(19) United States
(12) Patent Application Publication
(10) Pub. No.: US 2024/0046215 A1
(43) Pub. Date: Feb. 8, 2024

(54) APPARATUS AND METHOD FOR DISTRIBUTED DATAFLOW EXECUTION IN A DISTRIBUTED ENVIRONMENT

(71) Applicant: Havelock JSC, Sofia (BG)

(72) Inventor: Marin Dilkov Kojuharov, Sofia (BG)

(21) Appl. No.: 17/880,405

(22) Filed: Aug. 3, 2022

(51) Int. Cl. G06Q 10/10; G06Q 10/06

(52) U.S. Cl. CPC G06Q 10/103; G06Q 10/063114; G06Q 10/06316; G06Q 10/06312

(57) ABSTRACT

The systems and methods described in this paper are for processing data objects in a database based on an actionability status of data object elements. The graphical user interfaces (GUI) for use in association with processing the data object and data object elements is described in greater detail. Additionally, the GUI dynamically displays actionability status of various tasks or milestones associated with a plurality of data objects and limits the presentation of, assignment of, and/or action on only data object elements which are immediately actionable such that other data object elements which are not immediately actionable are not readily viewable by all users.

### BACKGROUND

Current data object management systems generally require upkeep of large numbers of data object elements (e.g. tasks, milestones, etc.) each having corresponding characteristics such as deadlines, completion time estimates. In some cases a data object manager may be required to attend to thousands of data object elements in a single day. Furthermore, when circumstances change or events diverge from an initial plan, it may be necessary to update all subsequent data object elements to re-plan and/or re-assign elements to address the change, with many of these subsequent data object elements being unable to undergo any action yet. This can be overwhelming for a data object manager and consume a large amount of their time by requiring them to plan tasks which are not yet actionable. Ultimately, it is inefficient to regularly re-plan or re-assign tasks which cannot be acted on.

Furthermore, conventional approaches may involve substantial communication “noise” in the form of back and forth communications between different parties attempting to determine when they will be able to begin working on their portion of a project. Conventionally, project tasks may be assigned to responsible parties prior to them being able to begin working on the task which can lead to questions regarding when the previous task (dependency) will be completed so they can start their task which leads to increased communications which are generally not useful or productive, but instead draw attention away from actionable tasks towards those not actionable. For example, when one data object element is dependent on completion of a previous data object element, and all parties involved are aware of and readily able to view the dependency, there can be significant communication noise associated with inquiries on data object element progress (e.g. “when will you be done with your part so I can start on my part?”).

Moreover, existing software systems, by virtue of design, allow their users to manage projects according to a user's own discretion. These software systems generally fail to set a performance direction or a pattern to be followed and allow for deviation from a preferred or optimal progression.

### SUMMARY

The present invention addresses the above issues by providing systems, methods, and graphical user interfaces (GUIs) which direct focus to data object elements which are immediately actionable and prevents non-actionable data object elements from being readily available or viewable by users. In one aspect, data object managers will be limited to scheduling and/or assigning only schedule actionable tasks. In turn, users or parties responsible for task execution will only see their own actionable tasks which have been assigned to them and are prevented from viewing potential future tasks and their associated dependencies.

The present invention identifies next actionable steps and prioritizes them in a way such that data object managers are directed towards actionable, higher priority tasks and prevented from assigning/scheduling non-actionable, lower priority tasks. In one aspect, this is accomplished by dynamically re-sorting the list of actionable tasks/milestones available to a user based on project aspects such as deadline which leads to prioritizing the earlier deadline tasks ahead of others. In this way, the higher priority tasks should be assigned ahead of the lower priority tasks thus providing a more optimal scheduling of tasks in a way that can reduce the likelihood of delays in completing a project.

In one embodiment the invention comprises a computer implemented for managing a plurality of data objects based on an actionability status of at least one data object element, wherein the method comprises storing, by a cloud scheduler at a cloud server, a plurality of data objects scheduled for multiple executions over a period of time, the plurality of data objects comprising at least one of an execution deadline, an initial expected execution date, a dynamic expected execution date, a delay time, at least one data object element, wherein each data object element is associated with an actionability status, the actionability status determined based on at least one data object element dependency, wherein the actionability status comprises at least one of actionable, not actionable, and completed.

The computer implemented method may further comprise generating, by the cloud scheduler at the cloud server, a graphical user interface (GUI) for displaying at least one of the plurality of data objects.

The computer implemented method may further comprise providing remote access to a plurality of users over a network so each user is able to, in real time through the graphical user interface associated with each user, at least one of view at least a portion of the plurality of data objects, update at least a portion of the plurality of data objects, and provide status information associated with at least a portion of the plurality of data objects.

The computer implemented method may further comprise identifying, from the plurality of data objects, at least one actionable data object element, the at least one actionable data object element identified based on the actionability status wherein identifying comprises identifying at least one data object element having an actionability status of actionable.

The computer implemented method may further comprise obtaining status information associated with the at least one actionable data object element, the status information comprising information associated with progress of the actionable data object element.

The computer implemented method may further comprise automatically updating the stored plurality of data objects, the updating comprising updating at least the actionability status of at least one different data object element based on the obtained status information associated with the at least one actionable data object element.

The computer implemented method may further comprise updating, in real-time over the network, the plurality of data objects so that users have up to date information regarding a status of at least one of the plurality of data objects, the updating comprising providing the at least one identified actionable data object element.

The computer implemented method may comprise updating the plurality of data objects by providing, via the GUI, only data objects associated with actionable data object elements.

The computer implemented method may comprise updating the plurality of data objects by providing, via the GUI, only actionable data object elements.

The computer implemented method may comprise the at least one actionable data object element comprising at least one of an actionable milestone and an actionable task.

The computer implemented method may comprise the at least one data object element dependency comprising at least one of at least one milestone dependency and at least one task dependency.

The computer implemented method may comprise storing a plurality of different data objects and identifying a plurality of actionable data object elements associated with different data objects.

The computer implemented method may comprise automatically updating a graphical user interface to present a plurality of identified actionable data object elements in an order determined by a characteristic associated with the actionable data object element, the characteristic comprising at least one of a data object element deadline, a data object element time factor, a data object element notification setting, an associated execution deadline, an associated initial expected execution date, an associated dynamic expected execution date, and an associated delay time.

The computer implemented method may comprise an actionability status of actionable being associated with a data object element having no dependencies or a data object element whose dependencies have been satisfied, and wherein an actionability status of not actionable being associated with a data object element whose dependencies have not been satisfied.

The computer implemented method may further comprise automatically updating the actionability status of the at least one actionable data object element based on the obtained status information, wherein updating the the actionability status of the at least one actionable data object element comprises changing the actionability status of the at least one actionable data object element from actionable to completed.

The computer implemented method may comprise automatically updating the actionability status of the at least one different data object element by changing the actionability status of the at least one different data object element from not actionable to actionable based on at least one of the obtained status information associated with the at least one actionable data object element and an updated actionability status associated with the at least one actionable data object element.

The computer implemented method may further comprise obtaining assignment information associated with the at least one actionable data object element, the assignment information comprising at least one of a department, an individual, and a plurality of individuals responsible for performing actions associated with completing the at least one actionable data object element, wherein updating the plurality of data objects comprises providing, via the GUI, a plurality of data objects so that each user associated with the assignment information has immediate access to up to date data objects.

The computer implemented method may further comprise automatically assigning the at least one actionable data object element based on the obtained assignment information.

The computer implemented method may comprise automatically updating the plurality of data objects further by updating at least one of the dynamic expected execution date and the delay time.

The computer implemented method may comprise the plurality of data objects comprised of a plurality of data objects for each of a plurality of different projects.

The computer implemented method may comprise the graphical user interface associated with each user being automatically updated to present only identified actionable data object elements which have been assigned to the user.

The computer implemented method may further comprise the identified actionable data object elements accessible by a first user through the graphical user interface being different than the identified actionable data object elements accessible by a second user through the graphical user interface.

The computer implemented method may comprise automatically updating a graphical user interface associated with each user to present only identified actionable data object elements which have been assigned to the user.

The computer implemented method may comprise storing the plurality of data objects in a standardized format, wherein updating comprises converting status information obtained in a non-standardized format to an actionability status in the standardized format and wherein updating comprises providing, via the GUI, the plurality of data objects in the standardized format.

In one embodiment the invention comprises a system for managing a plurality of data objects based on an actionability status of at least one data object elements, the system comprising control circuitry configured to perform a method comprising storing, by a cloud scheduler at a cloud server, a plurality of data objects scheduled for multiple executions over a period of time, the plurality of data objects comprising at least one of an execution deadline, an initial expected execution date, a dynamic expected execution date, a delay time, at least one data object element, wherein each data object element is associated with an actionability status, the actionability status determined based on at least one data object element dependency, wherein the actionability status comprises at least one of actionable, not actionable, and completed.

The control circuitry may be further configured to generate, by the cloud scheduler at the cloud server, a graphical user interface (GUI) for displaying at least one of the plurality of data objects.

The control circuitry may be further configured to provide remote access to a plurality of users over a network so each user is able to, in real time through the graphical user interface associated with each user, at least one of view at least a portion of the plurality of data objects, update at least a portion of the plurality of data objects, and provide status information associated with at least a portion of the plurality of data objects.

The control circuitry may be further configured to identify, from the plurality of data objects, at least one actionable data object element, the at least one actionable data object element identified based on the actionability status wherein identifying comprises identifying at least one data object element having an actionability status of actionable

The control circuitry may be further configured to obtain status information associated with the at least one actionable data object element, the status information comprising information associated with progress of the actionable data object element.

The control circuitry may be further configured to automatically update the stored plurality of data objects, the updating comprising updating at least the actionability status of at least one different data object element based on the obtained status information associated with the at least one actionable data object element.

The control circuitry may be further configured to update, in real-time over the network, the plurality of data objects so that users have up to date information regarding a status of at least one of the plurality of data objects, the updating comprising providing the at least one identified actionable data object element.

In one embodiment the invention comprises a non-transitory computer readable medium comprising instructions that, when executed by a processor, cause the processor to perform a method for managing a plurality of data objects based on an actionability status of at least one data object elements, the method comprising storing, by a cloud scheduler at a cloud server, a plurality of data objects scheduled for multiple executions over a period of time, the plurality of data objects comprising at least one of an execution deadline, an initial expected execution date, a dynamic expected execution date, a delay time, at least one data object element, wherein each data object element is associated with an actionability status, the actionability status determined based on at least one data object element dependency, wherein the actionability status comprises at least one of actionable, not actionable, and completed.

The non-transitory computer readable medium may further comprise instructions enabling a processor to generate, by the cloud scheduler at the cloud server, a graphical user interface (GUI) for displaying at least one of the plurality of data objects;

The non-transitory computer readable medium may further comprise instructions enabling a processor to provide remote access to a plurality of users over a network so each user is able to, in real time through the graphical user interface associated with each user, at least one of view at least a portion of the plurality of data objects, update at least a portion of the plurality of data objects, and provide status information associated with at least a portion of the plurality of data objects.

The non-transitory computer readable medium may further comprise instructions enabling a processor to identify, from the plurality of data objects, at least one actionable data object element, the at least one actionable data object element identified based on the actionability status wherein identifying comprises identifying at least one data object element having an actionability status of actionable

The non-transitory computer readable medium may further comprise instructions enabling a processor to obtain status information associated with the at least one actionable data object element, the status information comprising information associated with progress of the actionable data object element.

The non-transitory computer readable medium may further comprise instructions enabling a processor to automatically update the stored plurality of data objects, the updating comprising updating at least the actionability status of at least one different data object element based on the obtained status information associated with the at least one actionable data object element.

The non-transitory computer readable medium may further comprise instructions enabling a processor to update, in real-time over the network, the plurality of data objects so that users have up to date information regarding a status of at least one of the plurality of data objects, the updating comprising providing the at least one identified actionable data object element.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system for project coordination and management in accordance with an exemplary embodiment of the invention.

FIG. 2A illustrates a data object management system in accordance with an exemplary embodiment of the present invention.

FIG. 2B illustrates an exemplary graphical user interface (GUI) according to an exemplary embodiment of the present invention.

FIG. 2C illustrates exemplary graphical user interface (GUI) according to an exemplary embodiment of the present invention.

FIG. 2D illustrates exemplary graphical user interface (GUI) according to an exemplary embodiment of the present invention.

FIG. 3A illustrates an exemplary process for management of a plurality of data objects according to one embodiment of the invention.

FIG. 3B illustrates an exemplary process for controlling a graphical user interface for project management and coordination according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

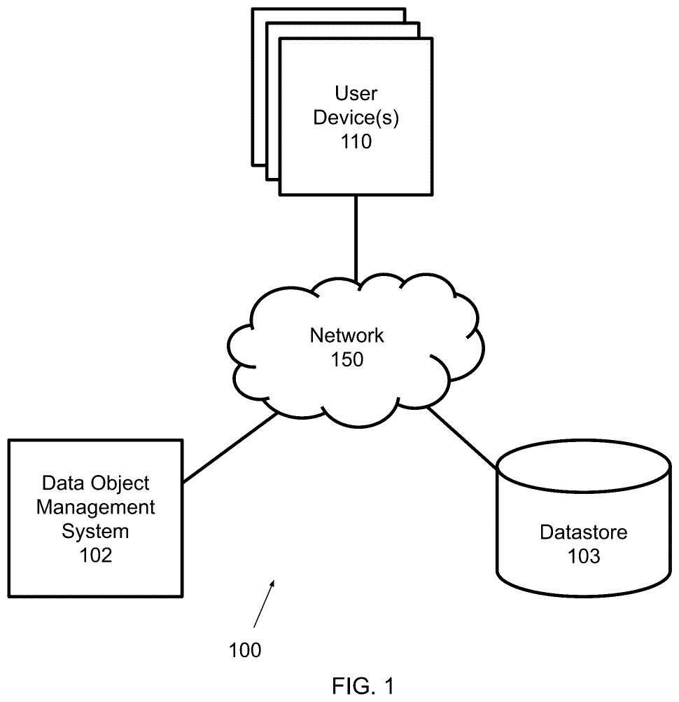

FIG. 1 illustrates an exemplary embodiment of a system 100 for project coordination and management according to one embodiment. The system includes user device(s) 110, data object management system 102, datastore 103, and a network 150 over which the various systems communicate and interact. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention.

As a general overview, a user interacts with data object management system 102 via at least one graphical user interface associated with the user's user device 110. Data object management system 102 obtains a plurality of data objects from at least one of datastore 103 and user device(s) 110, processes a plurality of data objects to determine actionability of data object elements, and provides at least one graphical user interface (GUI) for use by user device(s) 110 in displaying a plurality of data objects. As used herein, data object elements generally refers to aspects of a project which need to be completed, such as project tasks and project milestones. In one aspect, each data object element comprises a portion of an overall project, the portions when combined collectively making up a substantial part, if not all, of what must be executed in order to complete the overall project (or at least a significant portion thereof). In one aspect, a milestone may simply be a task, may comprise a task of particular importance to the overall project, or may comprise a group of tasks that once complete signify particular importance to the overall project progress.

Data object management system 102 is operable to provide project management functionality including, but not limited to, at least one of data object display, filtering, sorting, tracking, and storing, assignment of data object elements to users, GUI control, project communication, and determination of data object element actionability status. Data object management system 102 may be and/or comprise a cloud scheduler at a cloud server. Data object management system 102 may obtain a plurality of data objects from a plurality of data objects stored in datastore 103 and a plurality of data objects from user device(s) 110. Obtained plurality of data objects may comprise at least one of an execution deadline, an initial expected execution date, a dynamic expected execution date, a delay time, at least one data object element (such as milestones and tasks), data object element reminders, data object element priority status, and data object element dependencies indicating which, if any, data object elements must be completed before at least one other data object element may start (or undergo action). In one aspect, data object element dependencies comprise at least one of task dependency(ies) and milestone dependency(ies). These are merely exemplary data object items and the plurality of data objects may comprise a plurality of any one or more of these elements among other data items as would be apparent to one of ordinary skill in the art. A plurality of data objects may comprise a plurality of data objects associated with an individual project and/or a plurality of projects wherein the plurality of data objects for each project may comprise a plurality of the above listed exemplary data object items.

Data object management system 102 identifies, using at least the data object dependency data, an actionability status for each data object element. In one aspect, the actionability status may comprise a status of actionable, not actionable, and complete. For example, when all dependencies associated with a given data object element have been satisfied or completed, the actionability status of the given data object element may be set as actionable. When at least one dependency associated with a given data object element has not been satisfied or completed, the actionability status of the given data object element may be set as not actionable. When a given data object element has been finished, the actionability status of the given data object element may be set as completed. The actionability status of other data object elements having a dependency on the given data object element are modified or updated accordingly, upon setting the actionability status of a given data object element as completed, such as setting a data object element as actionable or changing an actionability status from not actionable to actionable. These actionability statuses are merely exemplary and other statuses may be used as would be apparent to one of ordinary skill in the art. By way of example, and not limitation, other statuses may include settings such as pending, awaiting completion of another data object element, in progress, ongoing, canceled, and the like. In one aspect, the actionability status drives what information is provided to users and what actions may be performed by a data object manager through data object management system 102. For example, in one aspect, only data object elements having an actionable status of actionable are at least one of able to be viewed and able to be scheduled for action or assigned to a task performer for action towards completion. In this way, all users associated with a project can be limited to assigning, scheduling, or viewing data object elements which can be acted on immediately (i.e. without waiting for another data object element to be completed). By limiting users to only actionable tasks, the number of data object elements a user needs to address on a daily or weekly basis is substantially reduced. Furthermore, the number of communications between users regarding questions around when they can start on a given task are eliminated or reduced since users are only presented with tasks they can immediately act on and thus prevented from inquiring about future, unactionable tasks since they are not presented with information regarding the existence of such tasks.

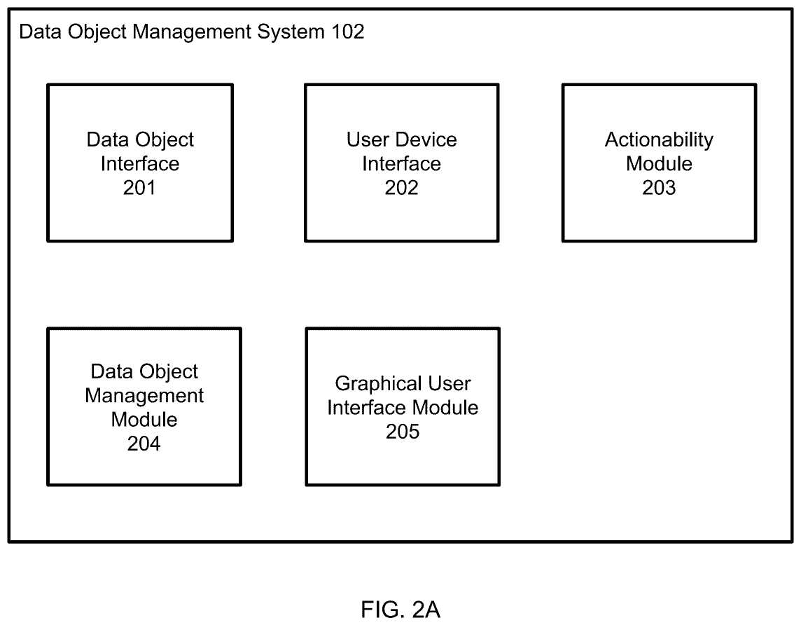

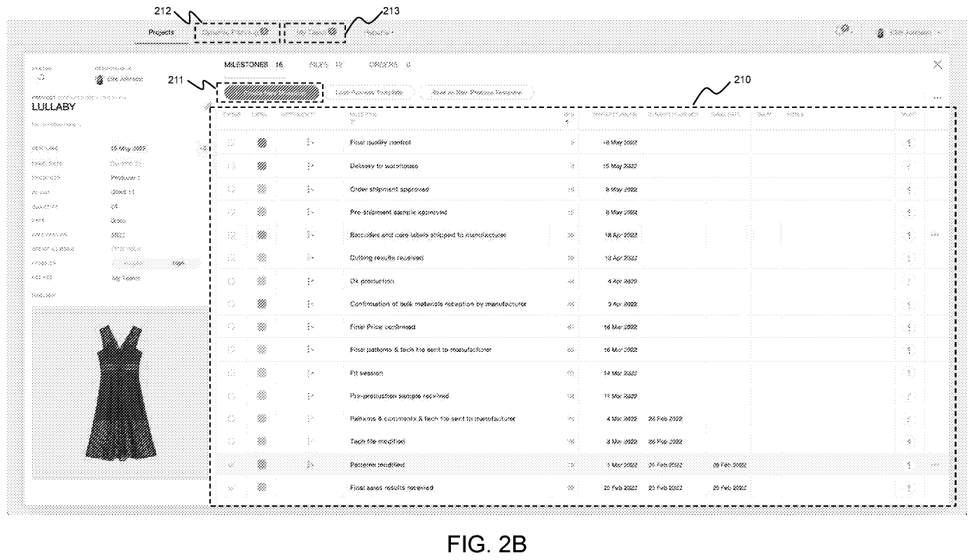

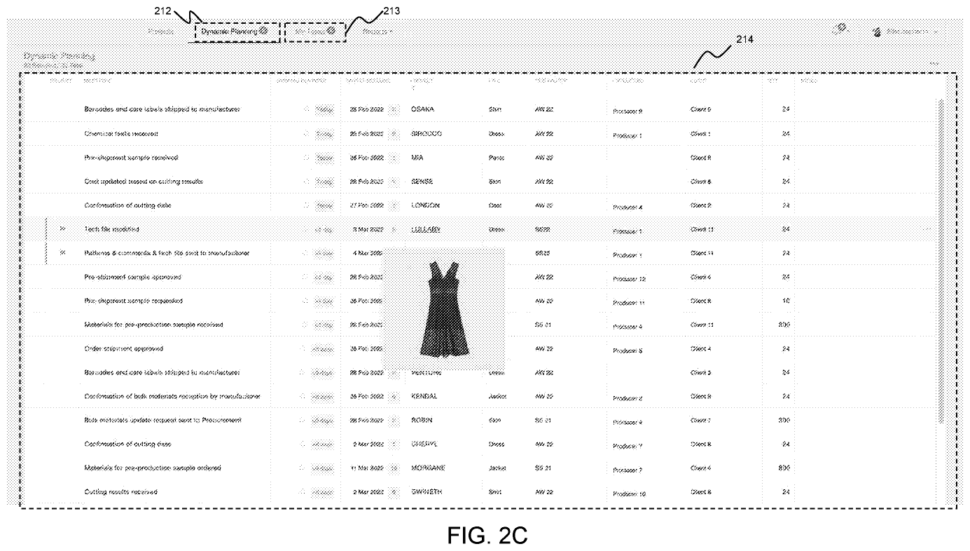

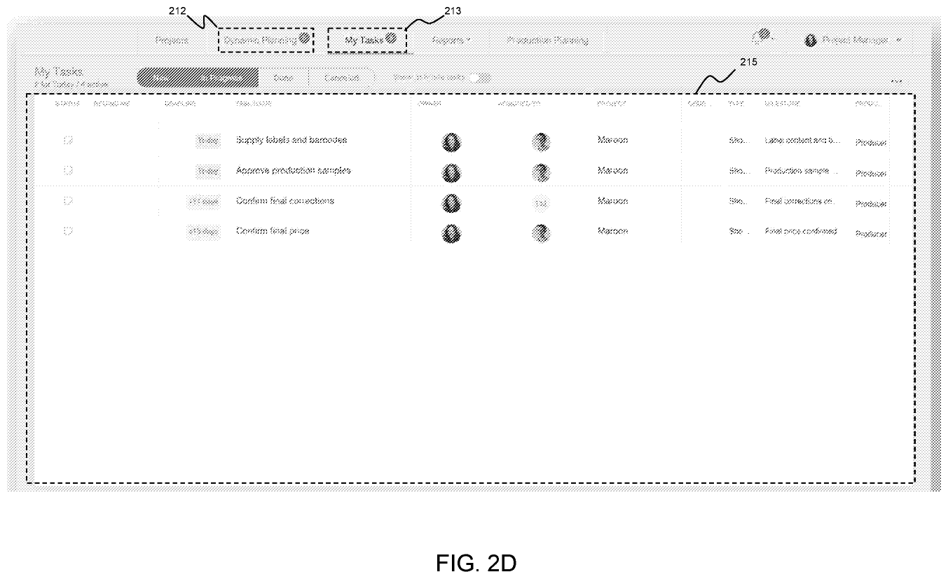

Data object management system 102 may generate and control one or more GUIs for at least one of obtaining and displaying at least one of a plurality of data objects, data object element information, actionability status, communications associated with projects, project reminders, project status or progress information, and the like. Data object management system 102 may control one or more GUIs in association with automatic sorting and/or re-sorting of a plurality of data objects in association with project actionability status or changes in project actionability status. For example, when a given data object element becomes actionable, data object management system 102 may automatically, in real-time, evaluate a priority status associated with the given data object element in relation to other actionable data object elements. Data object management system 102 may re-sort actionable data object elements based on their respective priority status. In one aspect, the priority status may be determined in association with at least one of an execution deadline, a number of dependencies associated with a data object element, a computed delay time, availability of performers responsible for completing a data object element, and the like. Upon re-sorting or updating an order of data object elements, the data object management system 102 may automatically control the one or more GUIs to display, in real-time, the updated or re-sorted plurality of data objects. The data object management system 102 is described in more detail below with respect to FIG. 2.

Datastore 103 generally comprises at least one computer readable medium for storing at least one of a plurality of data objects and user data associated with data object management system 102 and user device(s) 110. Datastore 103 is operable to provide data to at least one of data object management system 102 and user device(s) 110. Datastore 103 is operable to receive data from at least one of data object management system 102 and user device(s) and update and/or store the received data in association with the relevant project(s) and/or user(s). Although depicted as a separate component, datastore 103 may be incorporated into data object management system 102. Datastore 103 may comprise a plurality of datastores located in the same or different locations.

User device(s) 110 include, generally, a computer or computing device including functionality for communicating (e.g., remotely) over a network 150. User device(s) 110 may be used by one or more users to interact with data object management system 102 in order to at least one of obtain a plurality of data objects, provide a plurality of data objects, and update or modify a plurality of data objects. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

FIG. 2 illustrates an exemplary embodiment of a data object management system 102 for use in system 100 of FIG. 1. The data object management system 102 comprises at least a data objects interface 201, user device interface 202, actionability module 203, data object management module 204, and GUI module 205. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met. Furthermore, the functions described herein may be performed in real-time such that all users associated with a given project are provided with up to date information regarding the status of a project or data object elements with which they are associated.

Data objects interface 201 is operable to at least one of obtain a plurality of data objects from at least one datastore, such as datastore 103, and provide a plurality of data objects to at least one of user device(s), such as user device(s) 110, and a datastore, such as datastore 103. Data objects interface 201 may convert a plurality of data objects from one form to another in order to convert a plurality of data objects into a suitable form for at least one of processing by components of the data object management system 102, storage in a datastore, and transmission to user device(s).

User device interface 202 is operable to at least one of obtain a plurality of data objects from at least one user device, such as user device(s) 110, and provide a plurality of data objects to at least one user device, such as user device(s) 110. User device interface 202 may convert a plurality of data objects from one form to another in order to convert a plurality of data objects into a suitable form for at least one of processing by components of the data object management system 102, storage in a datastore, and transmission to other user device(s). In one aspect, user device interface 202 provides data to user device(s) in association with a graphical user interface (GUI) as determined by GUI module 205 (described in more detail below).

Actionability module 203 is operable to at least obtain a plurality of data objects and determine an actionability status of associated data object elements. In general, the actionability status may comprise at least a status of actionable, not actionable, and completed. Actionability module 203 may obtain current actionability status information as part of the obtained plurality of data objects. Actionability status information comprises an actionability status for each data object element associated with a given project. Actionability module 203 may obtain data object element dependency data and determine an actionability status for each data object element based on the dependency data. For example, when a given data object element is dependent on other data object elements which have a status of completed, the given data object element actionability status may be determined to be actionable and updated accordingly. When a given data object element is dependent on other data object elements wherein at least one of those other data object elements has not yet been completed, the actionability status of the given data object element may be determined as not actionable. When a given data object element has or is determined to have an actionability status of completed, any data object elements dependent on the given data object element may be evaluated to determine if they are actionable by evaluating their other, if any, dependencies.

Actionability module 203 may obtain data object element status or progress information from users, such as via user device interface 202, and in response, at least one of determine and modify the actionability status of at least one associated data object element. For example, when actionability module 203 obtains data object element status information indicating a given data object element is complete (or has been completed), actionability module 203 may assign an actionability status of complete to the given data object element and subsequently evaluate any other data object element(s) having a dependency on the given data object element. The evaluation of other data object element(s) having a dependency on the given data object element may comprise determining and/or modifying the actionability status as described above. Actionability module 203 may trigger, upon any change in an actionability status of any data object element, action by the GUI module 205 to control and refresh the information being provided (e.g. displayed) to users, such as each user associated with the data object element.

Data objects management module 204 obtains and processes plurality of data objects and changes associated with plurality of data objects in order to at least one of maintain and/or provide up to date plurality of data objects to other systems and components as necessary, and provide control and/or functionality to allow users to interact with the plurality of data objects as appropriate as determined by the plurality of data objects management system 204. Data objects management module 204 may periodically evaluate a plurality of data objects in order to determine project status and update the project information to be provided to users such as project information to be presented via GUI elements. In one aspect, data objects management module 204 may evaluate a plurality of data objects in response to information from actionability module 203 indicating that an actionability status of a data object element has changed or indicating that a threshold amount of time has passed since an actionability status of a data object element has changed. In one aspect, Data objects management module 204, determines, based on information from actionability module 203, the next actionable data object elements and sets reminders for the next actionable data object elements. In one aspect, the reminders are automatically set based on at least one of a default reminder criteria and a user specific reminder criteria. In one aspect, the reminders are set based on input from a user, such as a data object manager. In one aspect, the reminders are set based on at least one of currently actionable task(s) and an associated expected time until completion of the currently actionable task(s). The reminders may be dynamically computed based on changes in data object element status/progress and/or time elapsed since the data object element was assigned and/or scheduled.

In one aspect, data objects management module 204 determines that a given data object element has not been scheduled or assigned due to at least one data object element dependency that has not been satisfied (e.g. completed) and in turn computes a delay time for at least one of the given data object element and the project as a whole. In one aspect, the delay time may be computed based on at least one time factor indicating how much time is allotted to completing at least one of current and future data object elements having dependencies associated with a given project. The delay time may be at least one of computed, recorded, tracked, and provided, in real-time, so that users are able to identify specific portions of a project (e.g. a data object element or groups of elements) that are causing delays. In one aspect, data objects management module 204 may identify when a delay time exceeds a threshold and initiate an intervention to address the delay such as flagging the data object element as requiring input from higher ranking decision makers to determine whether the delay is acceptable or whether intervention is needed to minimize, reduce, and/or eliminate the delay.

In one aspect, data objects management module 204 applies artificial intelligence and/or machine learning to evaluate at least one user behavior and make suggestions regarding next actionable data object elements. For example, in one aspect, data objects management module 204 may use data associated with historic performance information associated with at least one of individual task performers and groups of task performers (e.g. a particular department) in order to at least one of estimate when a data object element may be completed and recommend assignment of a currently actionable task to at least one individual task performer or group of task performers. In one aspect, data objects management module 204 may use data associated with historic data object manager assignment and/or scheduling data to determine at least one of which data object elements are likely to be actionable next and which task performers the actionable data object elements should be assigned to.

In one aspect, data objects management module 204 provides real-time access to a plurality of data objects indicating at least one of what was initially planned, what actually happened throughout progression of the project, and all communications, documentation and files associated with a project. In this way, the history or ongoing development of project progression, including delays and/or inefficiencies, can be observed and analyzed in real-time in order to allow for early intervention and/or adjustment of future projects in order to avoid similar downfalls.

GUI module 205 is operable to at least one of generate and update GUIs for displaying relevant data objects based on information obtained from at least one of data objects management system 204 and actionability module 203. GUI module 205 may dynamically update at least one of GUIs and user interface (UI) elements based on at least one of information from actionability module 203 and information from data objects management module 204. In one aspect, GUI module 205 determines an appropriate GUI for each user based on a characteristic associated with the user. For example, GUI module 205 may generate a first GUI for users who are data object managers, a second GUI for users who are managers of a given department, a third GUI for individual task performers, and so on. In one aspect, regardless of the user characteristics, GUI module 205 may control GUIs such that only data object elements that are actionable are able to be viewed, assigned, and/or scheduled. GUI module 205 may generate one or more GUIs each comprising one or more UI elements for employing various aspects of the invention. The UI elements discussed below may be part of the same GUI or different GUIs without departing from the scope of the invention as would be apparent to one of ordinary skill in the art.

GUI module 205 may generate and dynamically update a GUI comprising at least a first user interface (UI) element for displaying all data object elements associated with at least one of a project, a plurality of projects and a user. Such may be limited to use in association with certain users, such as data object managers and/or department managers. This first UI element may be operable to provide a user, such as a data object manager, with the ability to provide a plurality of data objects including at least one of creating and modifying data object elements, such as adding/modifying at least one of data object element name and/or description, data object element deadlines, data object element dependencies, data object element completion status, and data object element reminders. The first UI element may display the associated data object element data provided by users as well as additional data object element data as determined by at least one of the actionability module 203 and data objects management module 204. For example, the first UI element may display at least one of an actionability status, a completion date, a reminder date, and a delay time. The first UI element may dynamically display and update a plurality of data objects in real-time so that users have access to up to date project information as the plurality of data objects changes over time.

GUI module 205 may generate a GUI comprising at least a second UI element for displaying a plurality of data objects associated with dynamic planning aspects. In one aspect, the second UI element for displaying a plurality of data objects associated with dynamic planning aspects may be limited to certain users, such as data object managers, department managers, and/or other users with the ability to assign and or schedule data object elements. The second UI element may be operable to provide a user, such as a data object manager, with the ability to at least one of view, assign, and schedule actionable data object elements. In one aspect, the second UI element is operable to display only a subset of the plurality of data objects displayed in the first UI element, such as only displaying actionable data object elements as determined from at least one of actionability status module 203 and plurality of data objects management system 204. The second UI element may be configured to display at least one of data object element data, data object element name and/or description, data object element deadline, data object element reminder data, data object element assignment information, data object element time factor (which may indicate an amount of time needed for completion of the data object element), data object element delay time (e.g. whether ahead of schedule or behind schedule). The second UI element may dynamically display and update actionable data objects in real-time so that users have access to up to date actionable project information as the plurality of data objects change over time. In one aspect, as new data object elements become actionable, the second UI element may automatically update the display of a plurality of data objects so that users are provided with up to date information on newly actionable data object elements. In one aspect, dynamically updating comprises sorting or re-sorting a plurality of data objects provided in the second UI element such that actionable data object elements are provided in an order of highest priority. In one aspect, the priority may be determined as discussed above, for example, based on which data object element has the nearest deadline, whether a project which the data object element is associated with is ahead of or behind schedule (e.g. based on a delay time associated with the project), etc.

GUI module 205 may generate a GUI comprising at least a third UI element for displaying a plurality of data objects associated with data object elements which are actionable by at least one of an individual and a group of individuals (e.g. a department). In one aspect, the third UI element may display only data object elements which are immediately actionable by the user viewing the third UI element. In one aspect, the third UI element may display only data object elements which are immediately actionable and have been assigned by the user viewing the third UI element. The third UI element may display at least one of data object element name and/or description, data object element deadline, data object element actionability status, and data object element assignment information. In one aspect, the third UI element is configured to allow users to enter or provide status information associated with a data object element, such as providing an indication a data object element is complete or providing a degree of progress made on the data object element. The third UI element may dynamically display and update a plurality of data objects in real-time so that users have access to up to date project information as a plurality of data objects change over time. In one aspect, as new data object elements become actionable, or new assignment or scheduling information is obtained, the third UI element may dynamically update, in real-time, to provide up to date data objects to users.

FIG. 2B depicts an exemplary first UI element having a first region 210, a first icon, button or engageable item 211, a second icon, button or engageable item 212, and a third icon, button or engageable item 213. First region 210 may be operable to display a plurality of data objects as discussed above. First icon, button or engageable item 211, upon engagement (clicking, pressing, touching, tapping, selecting, etc.), enables creating at least one of a new data object element (e.g. milestone, task, etc.) and providing an associated plurality of data objects as described above. Second icon, button or engageable item 212, upon engagement, enables viewing of the second UI element described above and depicted in FIG. 2C. Third icon, button or engageable item 213, upon engagement, enables viewing of the third UI element described above and depicted in FIG. 2D. FIG. 2C depicts an exemplary second UI element having a first region 214 for displaying a plurality of data objects associated with actionable data object elements as described above. FIG. 2D depicts an exemplary third UI element having a first region 215 for displaying a plurality of data objects associated with actionable data object elements as described above. These GUIs and UI elements are merely exemplary and other variations of GUIs and UI elements may be used as would be apparent to one of ordinary skill in the art. In one aspect these UI elements may be part of the same GUI or different GUIs.

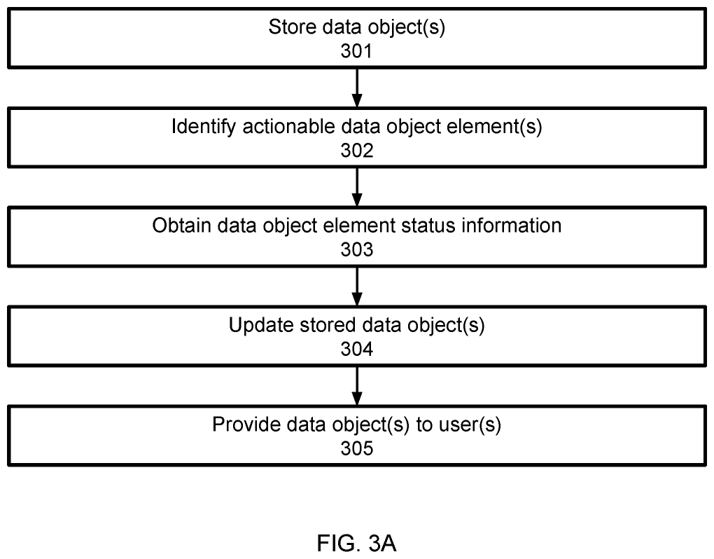

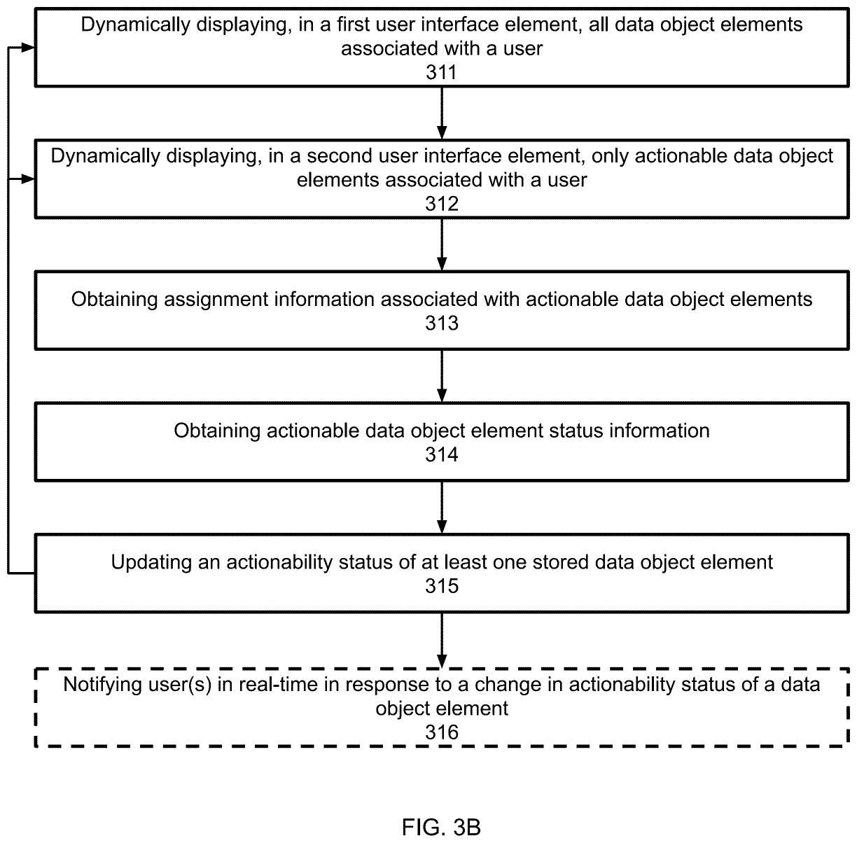

FIG. 3A illustrates an exemplary process for management of a plurality of data objects according to one embodiment of the invention. The process comprises storing a plurality of data objects 301, identifying actionable data object element(s) 302, obtaining data object element status information 303, updating stored data objects 304, and providing a plurality of data objects to user(s) 305. The process may comprise additional steps and/or a different order of steps as would be apparent to one of ordinary skill in the art without departing from the scope of the invention.

At step 301, the process may comprise storing a plurality of data objects. The plurality of data objects may be obtained as described above and may comprise at least one of a execution deadline, an initial expected execution date, a dynamic expected execution date, a delay time, at least one data object element, projecte element reminders, data object element priority status, and data object element dependencies indicating which, if any, data object elements must be completed before at least one other data object element may begin. Storing a plurality of data objects may comprise storing a plurality of data objects associated with one or a plurality of projects, each project having a plurality of data objects as described above.

At step 302, the process may comprise identifying actionable data object element(s). Identifying actionable items may be performed as described above in association with actionability module 203. Identifying actionable data object elements may comprise obtaining actionability status information from the stored plurality of data objects. Identifying actionable data object elements may comprise obtaining data object element dependency information from the stored plurality of data objects and determining an actionability status based on the dependency information. For example, if all data object element dependencies have been satisfied (e.g. completed) the actionability status of the data object element may be determined as actionable.

At step 303, the process may comprise obtaining data object element status information. Obtaining data object element status information may comprise obtaining from at least one of a stored plurality of data objects and user(s) provided status information associated with a given data object element. For example, when a data object element is completed, a user may provide such information, such as to a data object management system (e.g. data object management system 102) or by updating a database record (e.g. in datastore 103). In one aspect, data object element status information may comprise an indication of the degree of progress made on a data object element.

At step 304, the process may comprise updating the stored plurality of data objects based on the obtained status information. In one aspect, the stored plurality of data objects is only updated when obtained status information indicates a data object element has been completed. In this scenario, in addition to updating the stored plurality of data objects to indicate completion of the data object element, that actionability status of other data object elements may be updated based on data object element dependency information associated with the completed data object element. This update of actionability status may be performed as described above in association with actionability module 203. In one aspect, the stored plurality of data objects may be updated to indicate a degree of progress made on a data object element. In this scenario, the stored plurality of data objects associated with other data object elements may be updated, such as via updating a project reminder, based on the degree of progress information. For example, if the degree of progress information indicates that a data object element is nearing completion (e.g. has exceeded a threshold amount of progress), the stored plurality of data objects may be updated to indicate that a next data object element is likely to be actionable in the near future, such as by updating a dynamic reminder associated with the next data object element.

At step 305, the process may comprise providing up to date data objects to user(s). In one aspect, a plurality of data objects may be provided to users by dynamically updating at least one GUI and/or UI element in order to display the up to date plurality of data objects in real-time. Data may be provided to users as described above in association with data object management system 102, in particular GUI module 205. In one aspect, providing a plurality of data objects to users comprises providing only data objects associated with data object elements with an actionability status of actionable, while data object elements having an actionability status of not actionable are prevented from being provided to users.

FIG. 3B illustrates an exemplary process for controlling a graphical user interface for project management and coordination according to one embodiment of the invention. The process comprises dynamically displaying all data object elements associated with a user 311, dynamically displaying only actionable data object elements associated with a user 312, obtaining assignment information associated with actionable data object elements 313, obtaining actionable data object element status information 314, updating an actionability status of at least one stored data object element 315, and notifying users, in real-time, in response to a change in actionability status of a data object element 316. The process may comprise additional steps and/or a different order of steps as would be apparent to one of ordinary skill in the art without departing from the scope of the invention.

At step 311, the process may comprise dynamically displaying all data object elements associated with a user. In one aspect, this step may be limited to users having the ability to schedule and/or assign data object elements to other users. For example, data object managers may be able to view a dynamic display of all data object elements for projects which they are managing or otherwise associated with. In this way a data object manager may be enabled to view and/or modify plurality of data objects of data object elements associated with one or more projects, create new projects, add new data object elements to existing projects, and the like. The dynamically displaying all data object elements associated with a user may be performed in association with a first UI element such as that described above.

At step 312, the process may comprise dynamically displaying only actionable data object elements associated with a user. In one aspect, this step may provide users with the ability to at least one of schedule data object elements, assign data object elements, and provide status information associated with data object elements. The dynamically displaying only actionable data object elements associated with a user may be performed in association with at least one of a second UI element and a third UI element such as that described above in association with FIGS. 2A-D. For example, in the case of a data object manager, a second UI element may display all actionable data object elements which the data object manager has assigned or needs to assign to a task performer. In the case of a task performer, the third UI element may display all actionable data object elements which the task performer is responsible for completing. Furthermore, the third UI element may be operable to enable users to provide data object element status information such as whether a project has been completed or a degree of progress made on the data object element.

At step 313, the process may comprise obtaining assignment information associated with actionable data object elements. As described above in step 312, actionable data object elements may be displayed for a user, such as a data object manager, to assign actionable data object elements to other users. When a user interacts with a user interface to provide such information, assignment information is in turn obtained. In one aspect, obtaining assignment information comprises prompting a user to provide assignment information such as when a data object element has become actionable or when an actionable data object element has yet to be assigned to a user. In one aspect, obtaining assignment information comprises a user engaging an icon, button or other engageable item in order to initiate providing of assignment information.

At step 314, the process may comprise obtaining actionable data object element status information. As described above in step 312, actionable data object elements may be displayed for a user, such as a task performer, to view and/or provide status information. In one aspect, obtaining status information comprises prompting a user to provide status information such as when a threshold duration of time has passed since the data object element was assigned to the user, a threshold duration of time has passed since the data object element began, a threshold duration of time has passed since status information has been obtained (e.g. since the previous status update, if one exists), and/or when a data object element is within a threshold duration of a target deadline. In one aspect, obtaining assignment information comprises a user engaging an icon, button or other engageable item in order to initiate providing of status information, such as engaging with such items in order to indicate a data object element is complete or enter a progress update.

At step 315, the process may comprise updating an actionability status of at least one stored data object element based on the obtained status information. Updating an actionability status may be performed as described above, such as in association with actionabilty module 203. In one aspect, updating an actionability status comprises determining and updating at least one actionability status based on the obtained status information such that when obtained status information associated with a given data object element indicates the given data object element is complete. In one aspect updating comprises determining an actionability status of each data object element having a dependency on the completed data object element whose status information was obtained. In one aspect updating comprises changing at least one data object element from not actionable to actionable as a result of the obtained status information. Upon updating actionability status information, the process may proceed to at least one of dynamically displaying all data object element associated with a user to reflect the updated actionability status, dynamically displaying only actionable data object elements associated with a user to reflect the updated actionability status, and notifying users of a change in actionability status as a result of the updating.

At step 316, the process may, optionally, comprise notifying user(s) in real-time of a change in actionability status of a data object element. In one aspect, notifying user(s) of a change in actionability status comprises adjusting the dynamic display of a plurality of data objects such that it becomes readily apparent to a user that a new actionable data object element is available to the user for action. In one aspect, notifying user(s) in real time comprises prompting a user of the change in actionability status and the effects of that change on other data object elements the user is associated with. In one aspect, prompting comprises requiring the user to acknowledge receipt of the notification and obtaining an indication of such acknowledgement.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

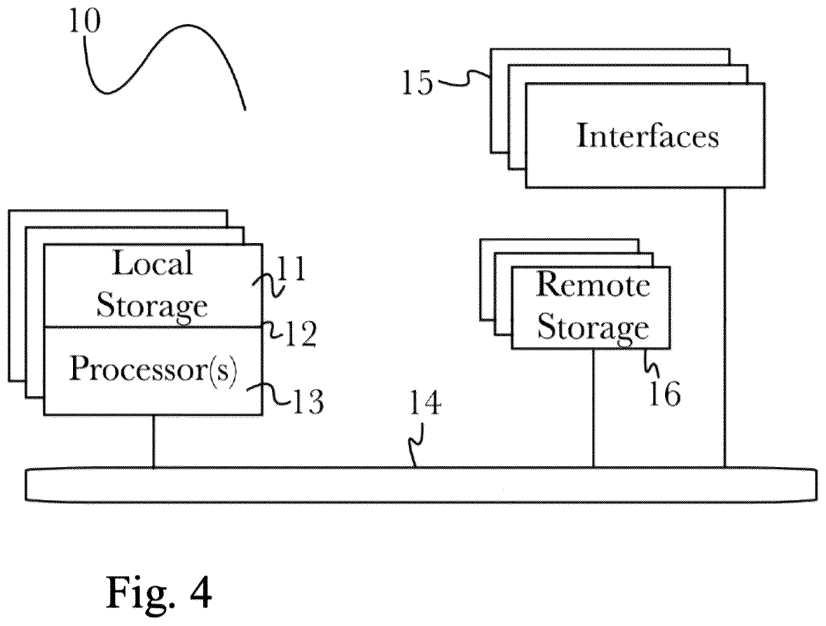

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components or the like may be and/or comprise hardware and/or software as described herein. For example, the data object management system 102 and subcomponents thereof may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

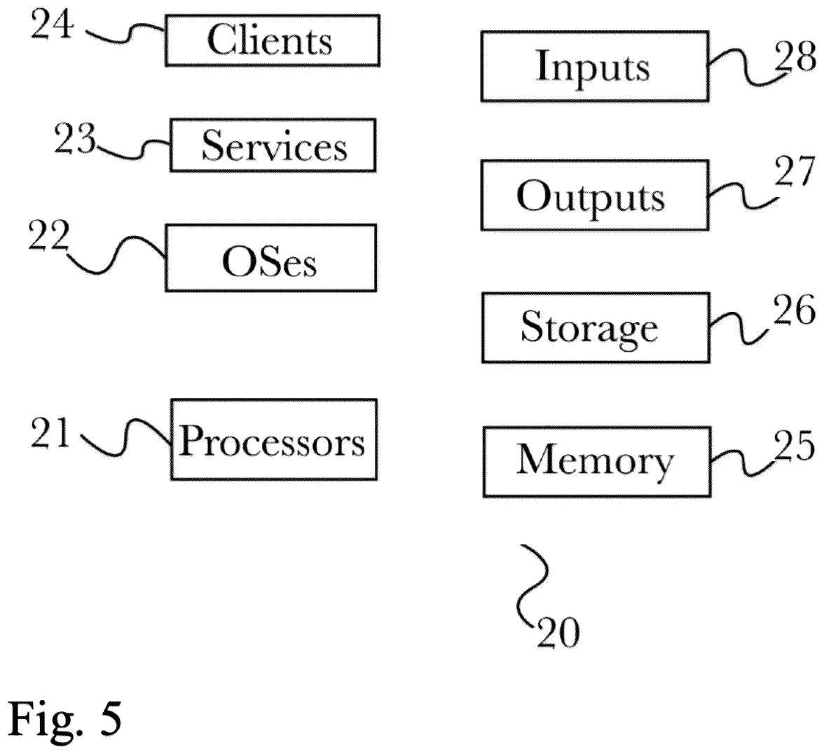

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

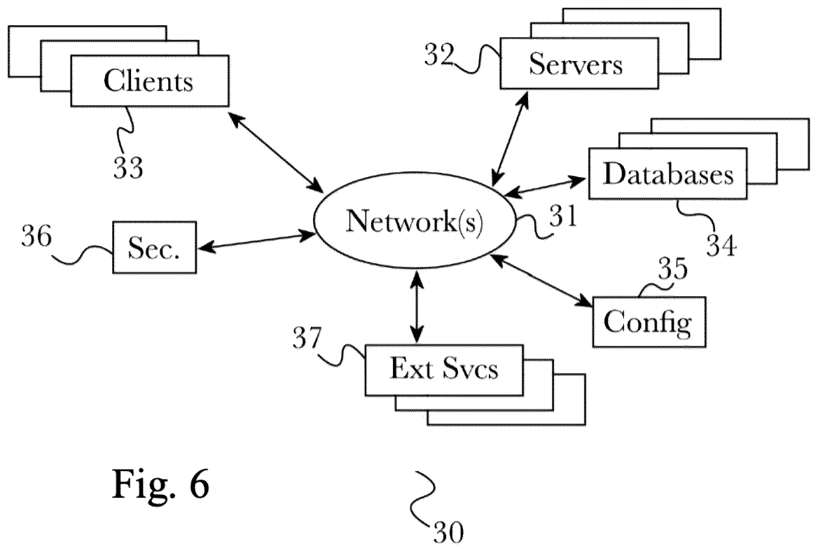

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

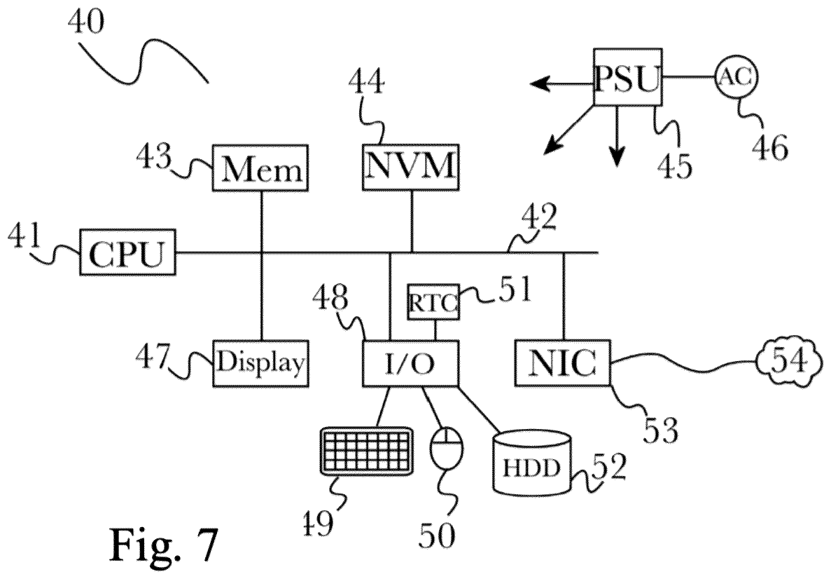

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/0 unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In one aspect, data objects may comprise projects and/or project data wherein the techniques disclosed herein are applicable to project management systems and methods. In one aspect, data object elements may comprise project elements such as project tasks and project milestones and their associated characteristics.

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented for managing a plurality of data objects based on an actionability status of at least one data object element, the method comprising:
storing, by a cloud scheduler at a cloud server, a plurality of data objects scheduled for multiple executions over a period of time, the plurality of data objects comprising at least one of an execution deadline, an initial expected execution date, a dynamic expected execution date, a delay time, at least one data object element, wherein each data object element is associated with an actionability status, the actionability status determined based on at least one data object element dependency, wherein the actionability status comprises at least one of actionable, not actionable, and completed;
generating, by the cloud scheduler at the cloud server, a graphical user interface (GUI) for displaying at least one of the plurality of data objects;
providing remote access to a plurality of users over a network so each user is able to, in real time through the graphical user interface associated with each user, at least one of view at least a portion of the plurality of data objects, update at least a portion of the plurality of data objects, and provide status information associated with at least a portion of the plurality of data objects;
identifying, from the plurality of data objects, at least one actionable data object element, the at least one actionable data object element identified based on the actionability status wherein identifying comprises identifying at least one data object element having an actionability status of actionable;
obtaining status information associated with the at least one actionable data object element, the status information comprising information associated with progress of the actionable data object element;
automatically updating the stored plurality of data objects, the updating comprising updating at least the actionability status of at least one different data object element based on the obtained status information associated with the at least one actionable data object element; and
updating, in real-time over the network, the plurality of data objects so that users have up to date information regarding a status of at least one of the plurality of data objects, the updating comprising providing the at least one identified actionable data object element.

2. The computer implemented method of claim 1, wherein updating the plurality of data objects comprises providing, via the GUI, only data objects associated with actionable data object elements.

3. The computer implemented method of claim 1, wherein updating the plurality of data objects comprises providing, via the GUI, only actionable data object elements.

4. The computer implemented method of claim 1, wherein the at least one actionable data object element comprises at least one of an actionable milestone and an actionable task.

5. The computer implemented method of claim 1, wherein the at least one data object element dependency comprises at least one of at least one milestone dependency and at least one task dependency.

6. The computer implemented method of claim 1, wherein storing the plurality of data objects comprises a plurality of different data objects and wherein identifying comprises identifying a plurality of actionable data object elements associated with different data objects.

7. The computer implemented method of claim 6, wherein updating comprises automatically updating a graphical user interface to present a plurality of identified actionable data object elements in an order determined by a characteristic associated with the actionable data object element, the characteristic comprising at least one of a data object element deadline, a data object element time factor, a data object element notification setting, an associated execution deadline, an associated initial expected execution date, an associated dynamic expected execution date, and an associated delay time.

8. The computer implemented method of claim 1, wherein an actionability status of actionable is associated with a data object element having no dependencies or a data object element whose dependencies have been satisfied, and wherein an actionability status of not actionable is associated with a data object element whose dependencies have not been satisfied.

9. The computer implemented method of claim 1, further comprising automatically updating the actionability status of the at least one actionable data object element based on the obtained status information, wherein updating the actionability status of the at least one actionable data object element comprises changing the actionability status of the at least one actionable data object element from actionable to completed.

10. The computer implemented method of claim 1, wherein automatically updating the actionability status of the at least one different data object element comprises changing the actionability status of the at least one different data object element from not actionable to actionable based on at least one of the obtained status information associated with the at least one actionable data object element and an updated actionability status associated with the at least one actionable data object element.

11. The computer implemented method of claim 1, further comprising obtaining assignment information associated with the at least one actionable data object element, the assignment information comprising at least one of a department, an individual, and a plurality of individuals responsible for performing actions associated with completing the at least one actionable data object element, wherein updating the plurality of data objects comprises providing, via the GUI, a plurality of data objects so that each user associated with the assignment information has immediate access to up to date data objects.

12. The computer implemented method of claim 1, further comprising automatically assigning the at least one actionable data object element based on the obtained assignment information.

13. The computer implemented method of claim 1, wherein automatically updating the plurality of data objects further comprises updating at least one of the dynamic expected execution date and the delay time.

14. The computer implemented method of claim 1, wherein the plurality of data objects comprises a plurality of data objects for each of a plurality of different projects.

15. The computer implemented method of claim 1, wherein the graphical user interface associated with each user is automatically updated to present only identified actionable data object elements which have been assigned to the user.

16. The computer implemented method of claim 1, wherein the identified actionable data object elements accessible by a first user through the graphical user interface are different than the identified actionable data object elements accessible by a second user through the graphical user interface.

17. The computer implemented method of claim 1, wherein the updating comprises automatically updating a graphical user interface associated with each user to present only identified actionable data object elements which have been assigned to the user.

18. The computer implemented method of claim 1, wherein storing comprises storing the plurality of data objects in a standardized format, wherein updating comprises converting status information obtained in a non-standardized format to an actionability status in the standardized format and wherein updating comprises providing, via the GUI, the plurality of data objects in the standardized format.

19. A system for managing a plurality of data objects based on an actionability status of at least one data object elements, the system comprising:
control circuitry configured to perform a method comprising:
storing, by a cloud scheduler at a cloud server, a plurality of data objects scheduled for multiple executions over a period of time, the plurality of data objects comprising at least one of an execution deadline, an initial expected execution date, a dynamic expected execution date, a delay time, at least one data object element, wherein each data object element is associated with an actionability status, the actionability status determined based on at least one data object element dependency, wherein the actionability status comprises at least one of actionable, not actionable, and completed;
generating, by the cloud scheduler at the cloud server, a graphical user interface (GUI) for displaying at least one of the plurality of data objects;
providing remote access to a plurality of users over a network so each user is able to, in real time through the graphical user interface associated with each user, at least one of view at least a portion of the plurality of data objects, update at least a portion of the plurality of data objects, and provide status information associated with at least a portion of the plurality of data objects;
identifying, from the plurality of data objects, at least one actionable data object element, the at least one actionable data object element identified based on the actionability status wherein identifying comprises identifying at least one data object element having an actionability status of actionable;
obtaining status information associated with the at least one actionable data object element, the status information comprising information associated with progress of the actionable data object element;
automatically updating the stored plurality of data objects, the updating comprising updating at least the actionability status of at least one different data object element based on the obtained status information associated with the at least one actionable data object element; and
updating, in real-time over the network, the plurality of data objects so that users have up to date information regarding a status of at least one of the plurality of data objects, the updating comprising providing the at least one identified actionable data object element.

20. A non-transitory computer readable medium comprising instructions that, when executed by a processor, cause the processor to perform a method for managing a plurality of data objects based on an actionability status of at least one data object elements, the method comprising:
storing, by a cloud scheduler at a cloud server, a plurality of data objects scheduled for multiple executions over a period of time, the plurality of data objects comprising at least one of an execution deadline, an initial expected execution date, a dynamic expected execution date, a delay time, at least one data object element, wherein each data object element is associated with an actionability status, the actionability status determined based on at least one data object element dependency, wherein the actionability status comprises at least one of actionable, not actionable, and completed;
generating, by the cloud scheduler at the cloud server, a graphical user interface (GUI) for displaying at least one of the plurality of data objects;
providing remote access to a plurality of users over a network so each user is able to, in real time through the graphical user interface associated with each user, at least one of view at least a portion of the plurality of data objects, update at least a portion of the plurality of data objects, and provide status information associated with at least a portion of the plurality of data objects;
identifying, from the plurality of data objects, at least one actionable data object element, the at least one actionable data object element identified based on the actionability status wherein identifying comprises identifying at least one data object element having an actionability status of actionable;
obtaining status information associated with the at least one actionable data object element, the status information comprising information associated with progress of the actionable data object element;
automatically updating the stored plurality of data objects, the updating comprising updating at least the actionability status of at least one different data object element based on the obtained status information associated with the at least one actionable data object element; and
updating, in real-time over the network, the plurality of data objects so that users have up to date information regarding a status of at least one of the plurality of data objects, the updating comprising providing the at least one identified actionable data object element.
